(19) United States
(12) Patent Application Publication
(10) Pub. No.: US 2025/0280091 A1
(43) Pub. Date: Sep. 4, 2025

(54) ELECTRONIC DEVICE THAT RESETS LOG-IN PASSWORD OF DEFAULT USER, DEVICE MANAGEMENT SYSTEM, COMPUTER-READABLE, NON-TRANSITORY RECORDING MEDIUM HAVING DEVICE CONTROL PROGRAM RECORDED THEREON, AND COMPUTER-READABLE, NON-TRANSITORY RECORDING MEDIUM HAVING DEVICE MANAGEMENT PROGRAM RECORDED THEREON

(71) Applicant: KYOCERA Document Solutions Inc., Osaka (JP)

(72) Inventor: Atsushi MATSUMOTO, Osaka (JP)

(73) Assignee: KYOCERA Document Solutions Inc., Osaka (JP)

(21) Appl. No.: 19/063,850

(22) Filed: Feb. 26, 2025

(30) Foreign Application Priority Data
Feb. 29, 2024 (JP) 2024-029526

(51) Int. Cl. H04N 1/44; H04N 1/00

(52) U.S. Cl. CPC H04N 1/4413; H04N 1/00244; H04N 1/00344; H04N 1/4433; H04N 2201/0094

(57) ABSTRACT

An electronic device includes a communication device, a storage device, and a control device that acts as a device controller. The communication device communicates with an external device. The storage device stores therein a log-in password and a default value of a default user. The device controller resets, upon receipt of a request to reset the log-in password via the communication device, the log-in password of the default user, by rewriting the log-in password to the default value.

### INCORPORATION BY REFERENCE

This application claims priority to Japanese Patent Application No. 2024-029526 filed on Feb. 29, 2024, the entire contents of which are incorporated by reference herein.

### BACKGROUND

The present disclosure relates to an electronic device that requires a password to log in, a device management system, a computer-readable, non-transitory recording medium having a device control program recorded thereon, and a computer-readable, non-transitory recording medium having a device management program recorded thereon.

A network system is widely known that includes multifunction peripherals, an example of the electronic device, and a management server acting as the device management system that manages the multifunction peripherals.

### SUMMARY

The disclosure proposes further improvement of the foregoing technique.

In an aspect, the disclosure provides an electronic device including a communication device, a storage device, and a control device. The communication device communicates with an external device. The storage device stores therein a log-in password of a default user and a default value. The control device includes a processor, and acts as a device controller, when the processor executes a device control program. The device controller resets, upon receipt of a request to reset the log-in password via the communication device, the log-in password of the default user, by rewriting the log-in password to the default value.

In another aspect, the disclosure provides a device management system that manages an electronic device. The device management system includes a communication device and a control device. The communication device communicates with an external device. The control device includes a processor, and acts as a device manager, when the processor executes a device management program. The device manager transmits a request to reset a log-in password of a default user, to the electronic device via the communication device.

In still another aspect, the disclosure provides a computer-readable, non-transitory recording medium having a device control program recorded thereon. The device control program is configured to cause an electronic device including a communication device that communicates with an external device, a storage device that stores therein a log-in password of a default user and a default value, and a processor, to act as a device controller, when the processor executes a device control program. The device controller resets, upon receipt of a request to reset the log-in password via the communication device, the log-in password of the default user, by rewriting the log-in password to the default value.

In still another aspect, the disclosure provides a computer-readable, non-transitory recording medium having a device management program for managing an electronic device, recorded thereon. The device management program is configured to cause a computer including a communication device that communicates with an external device, and a processor, to act as a device manager, when the processor executes the device management program. The device manager transmits a request to reset a log-in password of a default user, to the electronic device via the communication device.

### BRIEF DESCRIPTION OF THE DRAWINGS

FIG. 1 is a block diagram showing a configuration of a system according to an embodiment of the disclosure;

FIG. 2 is a block diagram showing a configuration of a device management system, constituted of a single computer;

FIG. 3 presents an example of device management information;

FIG. 4 is a block diagram showing a configuration of an image forming apparatus;

FIG. 5 presents an example of user management information;

FIG. 6 presents an example of default password information;

FIG. 7 presents an example of system connection information;

FIG. 8 is a block diagram showing an exemplary configuration of a user terminal;

FIG. 9 is a flowchart showing an operation of an image forming apparatus utilized by a device user;

FIG. 10 is a flowchart showing an operation of the image forming apparatus, performed when the device user logs in;

FIG. 11 presents an example of a log-in screen;

FIG. 12 is a flowchart showing an operation of the image forming apparatus, performed when the password of the default user is changed;

FIG. 13 presents an example of a password change screen;

FIG. 14 is a flowchart showing an operation of the device management system, performed upon receipt of a connection request from the image forming apparatus;

FIG. 15 is a flowchart showing an operation of the image forming apparatus, performed when an instruction to start system connecting action is inputted;

FIG. 16 presents an example of a system connection screen;

FIG. 17 is a flowchart showing an operation of the device management system, performed upon receipt of an instruction to reset the password of the default user of the image forming apparatus;

FIG. 18 and FIG. 19 are flowcharts each showing an operation of the image forming apparatus, performed upon receipt of a password reset request from the device management system; and

FIG. 20 presents an example of an approval screen.

### DETAILED DESCRIPTION

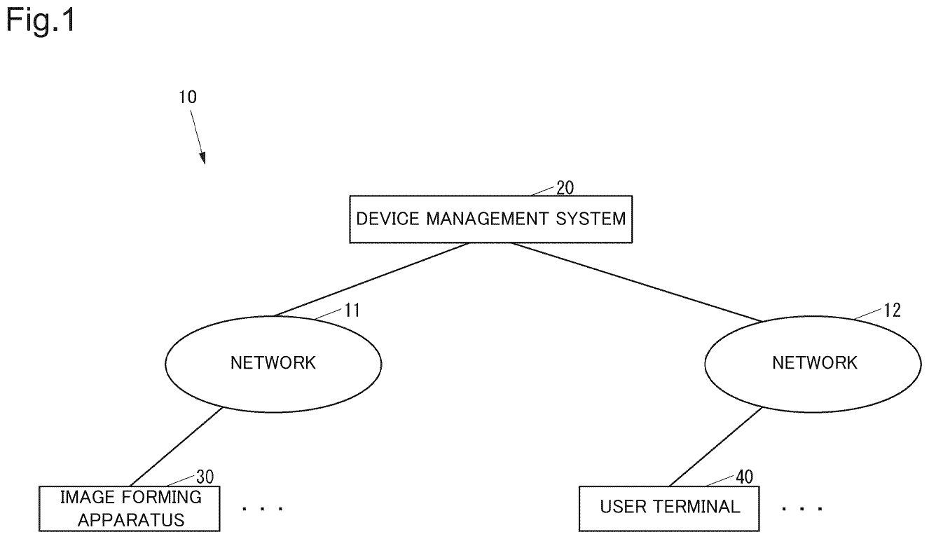

Hereafter, an embodiment of the disclosure will be described, with reference to the drawings. First, a configuration of a system according to the embodiment of the disclosure will be described. FIG. 1 is a block diagram showing the configuration of the system 10 according to the embodiment.

As shown in FIG. 1, the system 10 includes a device management system 20, for managing an image forming apparatus 30, exemplifying the electronic device. The device management system 20 may be constituted of a single computer such as a personal computer (PC), or a plurality of computers. The device management system 20 may be configured as a cloud server.

The device management system 20 is, for example, managed by the manufacturer of the image forming apparatus 30. The device management system 20 is utilized, for example, by a service person belonging to a service provider that provides the maintenance service for the image forming apparatus 30.

The system 10 includes the image forming apparatus 30, which may be, for example, a multifunction peripheral (MFP) or a single-function printer. The system 10 may include, in addition to the image forming apparatus 30, one or more image forming apparatuses configured similarly to the image forming apparatus 30.

The image forming apparatus 30 is, for example, installed at the location of the office of the user of the image forming apparatus 30, such as a customer of the service provider. To each of the image forming apparatuses 30, a device ID is assigned as identification information.

The system 10 includes a user terminal 40, for example a PC a smartphone, or a tablet terminal, to be utilized by the user of the device management system 20 such as a service person (hereinafter, “system user”). The system 10 may include, in addition to the user terminal 40, one or more user terminals configured similarly to the user terminal 40.

The device management system 20 and the image forming apparatus 30 can communicate with each other, via the network 11 such as a local area network (LAN) or the internet.

The device management system 20 and the user terminal 40 can communicate with each other, via the network 12 such as a LAN or the internet.

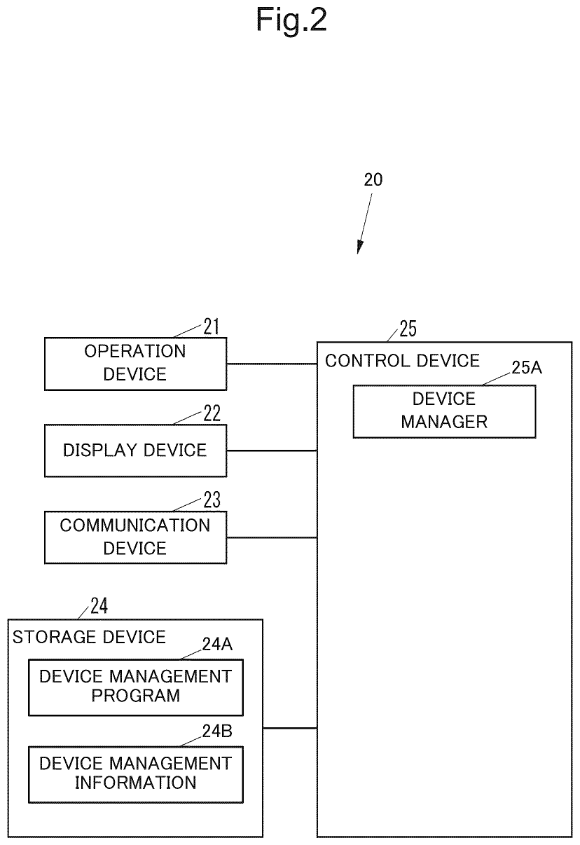

FIG. 2 is a block diagram showing a configuration of the device management system 20 constituted of a single computer. As shown in FIG. 2, the device management system 20 includes an operation device 21, a display device 22, a communication device 23, a storage device 24, and a control device 25.

The operation device 21 includes, for example, a keyboard and a mouse for inputting various operations. The display device 22 includes, for example, a liquid crystal display (LCD) for displaying various types of information. The communication device 23 performs communication with an external device, via a network such as a local area network (LAN) or the internet, or directly through wired or wireless communication.

The storage device 24 includes a non-volatile memory unit such as a semiconductor memory or a hard disk drive (HDD), for storing various types of information. The control device 25 controls the overall operation of the device management system 20.

The storage device 24 can store therein a device management program 24A, for managing the image forming apparatus 30. The device management program 24A may be, for example, installed in the device management system 20 during the manufacturing process thereof, additionally installed in the device management system 20 from an external storage medium such as a universal serial bus (USB) memory, or additionally installed in the device management system 20 from the network.

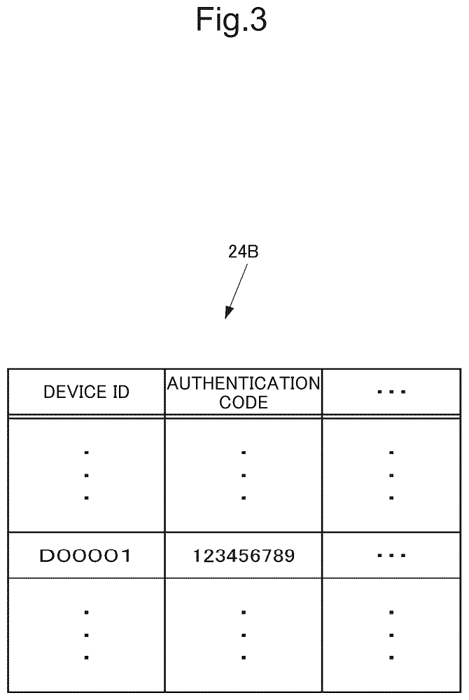

The storage device 24 can store therein device management information 24B for managing the image forming apparatus 30. FIG. 3 presents an example of the device management information 24B.

As shown in FIG. 3, the device management information 24B, includes a device ID, serving as the identification information of the image forming apparatus 30, and an authentication code that the image forming apparatus 30 needs when making connection to the device management system 20, in association with each of the image forming apparatuses 30. FIG. 3 shows a part of the content of the device management information 24B.

For example, the device management information 24B shown in FIG. 3 indicates that the image forming apparatus 30 having the device ID “D00001” has the authentication code “123456789”. The authentication code is generated in the device management system 20.

As shown in FIG. 2, the control device 25 includes, for example, a central processing unit (CPU), a read-only memory (ROM) containing programs and various types of data, and a random-access memory (RAM) serving as the operating region for the CPU of the control device 25. The CPU of the control device 25 executes the program stored in the storage device 24 or the ROM of the control device 25.

The control device 25 acts, by executing the device management program 24A, as a device manager 25A that manages the image forming apparatus 30.

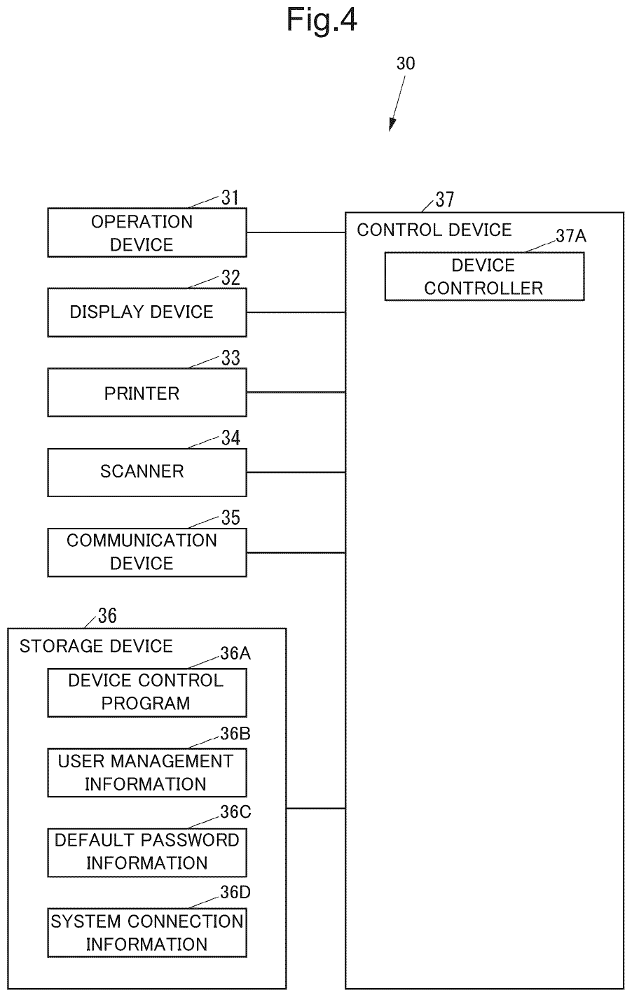

FIG. 4 is a block diagram showing a configuration of the image forming apparatus 30. As shown in FIG. 4, the image forming apparatus 30 includes an operation device 31, a display device 32, a printer 33, a scanner 34, a communication device 35, a storage device 36, and a control device 37.

The operation device 31 includes, for example, buttons for inputting various operations. The display device 32 includes, for example, an LCD for displaying various types of information. The printer 33 prints an image on a recording medium such as a paper sheet. The scanner 34 reads an image from a document.

The communication device 35 performs communication with an external device, via a network such as a LAN or the internet, or directly through wired or wireless communication. The storage device 36 includes a non-volatile memory unit such as a semiconductor memory or an HDD, for storing various types of information. The control device 37 controls the overall operation of the image forming apparatus 30.

The storage device 36 can store therein a device management program 36A, for managing the image forming apparatus 30. The device management program 36A may be, for example, installed in the image forming apparatus 30 during the manufacturing process thereof, additionally installed in the image forming apparatus 30 from an external storage medium such as a universal serial bus (USB) memory, or additionally installed in the image forming apparatus 30 from the network.

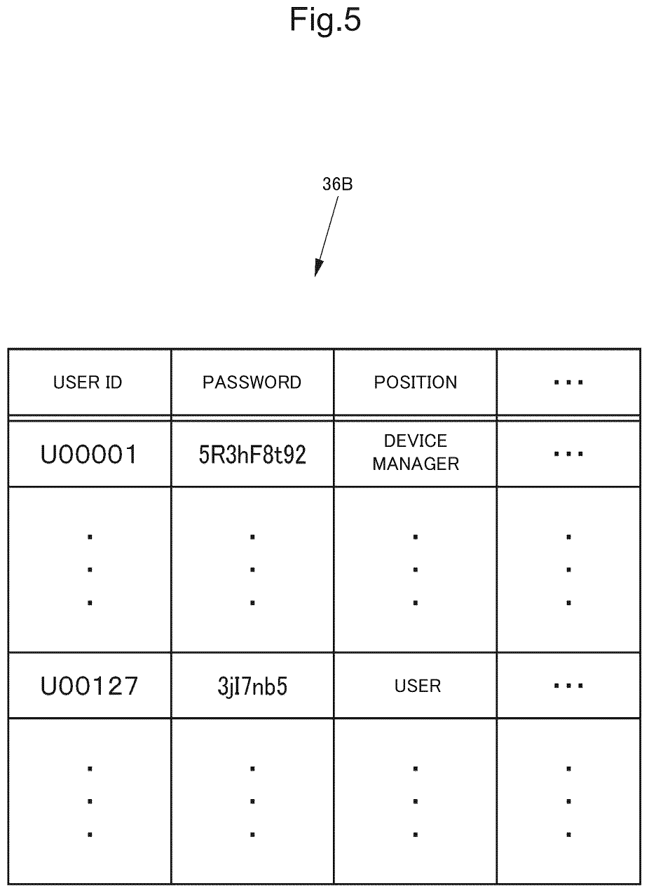

The storage device 36 stores therein user management information 36B for managing the user of the image forming apparatus 30 (hereinafter, “device user”). FIG. 5 presents an example of the user management information 36B.

As shown in FIG. 5, the user management information 36B includes the user ID serving as the identification information of the device user, the password, and the position with respect to the image forming apparatus 30, in association with each of the device users. FIG. 5 shows a part of the content of the user management information 36B.

In the user management information 36B shown in FIG. 5, the user ID “U00001” is the user ID of the default device user of the image forming apparatus 30 (hereinafter, “default user”). The default user is the device manager authorized to perform all types of operation with respect to the image forming apparatus 30.

As shown in FIG. 4, the storage device 36 stores therein default password information 36C, indicating the default password of the default user (hereinafter, “default password”). In the initial state of the image forming apparatus 30, the password of the default user in the user management information 36B accords with the default password indicated by the default password information 36C.

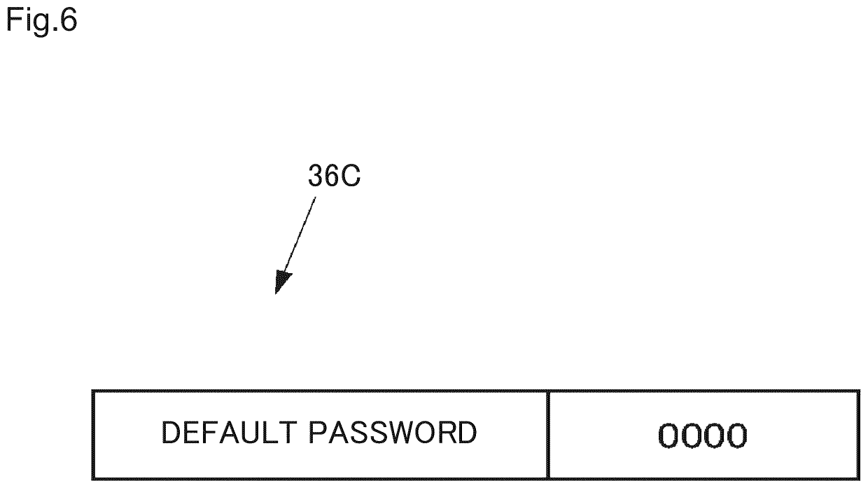

FIG. 6 presents an example of the default password information 36C. As shown in FIG. 6, the default password may be a simple character string, such as “0000”.

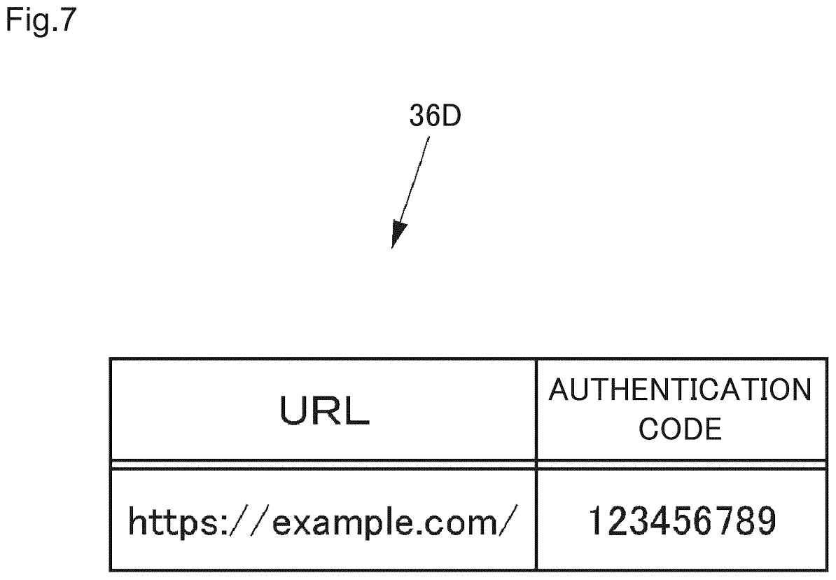

As shown in FIG. 4, the storage device 36 can store therein a system connection information 36D, necessary for the image forming apparatus 30 to establish connection to the device management system 20. FIG. 7 illustrates an example of the system connection information 36D.

As shown in FIG. 7, the system connection information 36D includes the uniform resource locator (URL) of the device management system 20, and the authentication code for establishing connection to the device management system 20.

As shown in FIG. 4, the control device 37 includes, for example, a CPU, a ROM containing programs and various types of data, and a RAM serving as the operation region for the CPU of the control device 37. The CPU of the control device 37 executes the program stored in the storage device 38 or the ROM of the control device 37.

The control device 37 acts, by executing the device control program 36A, as a device controller 37A the controls the image forming apparatus 30.

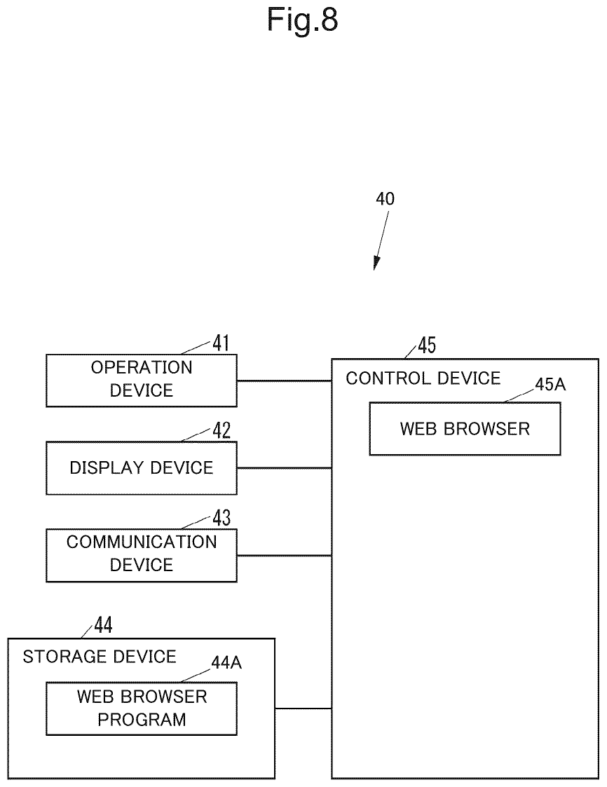

FIG. 8 is a block diagram showing an exemplary configuration of the user terminal 40. As shown in FIG. 8, the user terminal 40 includes an operation device 41, a display device 42, a communication device 43, a storage device 44, and a control device 45.

The operation device 41 includes, for example, a keyboard and a mouse for inputting various operations. The display device 42 includes, for example, an LCD for displaying various types of information. The communication device 43 performs communication with an external device, via a network such as a LAN or the internet, or directly through wired or wireless communication. The storage device 44 includes a non-volatile memory unit such as a semiconductor memory or an HDD, for storing various types of information. The control device 45 controls the overall operation of the user terminal 40.

The storage device 44 can store therein a web browser program 44A. The web browser program 44A may be, for example, installed in the user terminal 40 during the manufacturing process thereof, additionally installed in the user terminal 40 from an external storage medium such as a USB memory, or additionally installed in the user terminal 40 from the network.

The control device 45 includes, for example, a CPU, a ROM containing programs and various types of data, and a RAM serving as the operation region for the CPU of the control device 45. The CPU of the control device 45 executes the program stored in the storage device 44 or the ROM of the control device 45.

The control device 45 acts as a web browser 45A, by executing the web browser program 44A.

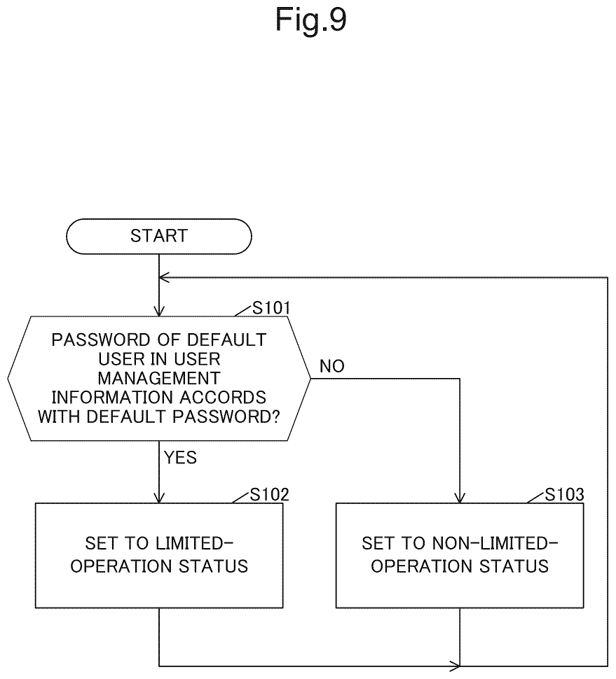

Hereunder, an operation of the system 10 will be described. First, the operation of the image forming apparatus 30, utilized by the device user, will be described. FIG. 9 is a flowchart showing the operation of the image forming apparatus 30 utilized by the device user. The device controller 37A of the image forming apparatus 30 always executes the operation specified in FIG. 9.

As shown in FIG. 9, the device controller 37A decides whether the password of the default user in the user management information 36B accords with the default password indicated by the default password information 36C (step S101).

Upon deciding that the password of the default user in the user management information 36B accords with the default password indicated by the default password information 36C (YES at step S101), the device controller 37A sets the image forming apparatus 30 to such a state that acceptance of operations other than a specific operation is limited (hereinafter, “limited-operation status”) (step S102).

In the limited-operation status, it is permitted, for example, to log in to the image forming apparatus 30 with the user ID of the default user, and to change the password of the default user in the user management information 36B.

In the limited-operation status, in contrast, for example, registration of a new device user other than the default user in the image forming apparatus 30, log-in to the image forming apparatus 30 with the user ID of the device user other than the default user, and input by the device user, of an instruction to start an action for connecting the image forming apparatus 30 to the device management system 20 (hereinafter, “instruction to start system connecting action”), are restricted.

Upon deciding that the password of the default user in the user management information 36B does not accord with the default password indicated by the default password information 36C (NO at step S101), the device controller 37A sets the image forming apparatus 30 to a status different from the limited-operation status (hereinafter, “non-limited-operation status”) (step S103).

After step S102 or step S103, the device controller 37A returns to step S101.

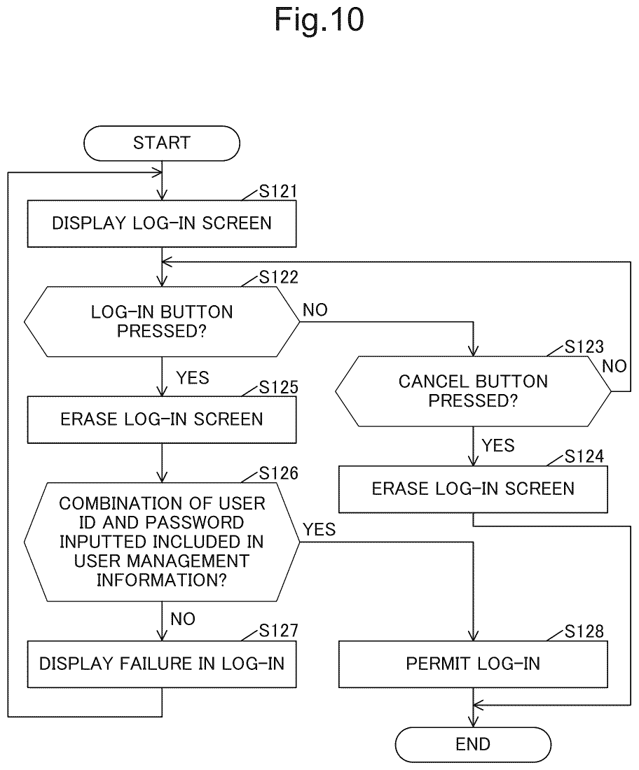

Hereunder, an operation of the image forming apparatus 30, performed when the device user logs in, will be described. FIG. 10 is a flowchart showing the operation of the image forming apparatus 30, performed when the device user logs in.

The device user can input an instruction to start the action for logging in to the image forming apparatus 30 (hereinafter, “log-in action start instruction”), through the operation device 31 to the image forming apparatus 30. When the log-in action start instruction is inputted, the device controller 37A of the image forming apparatus 30 executes the operation specified in FIG. 10.

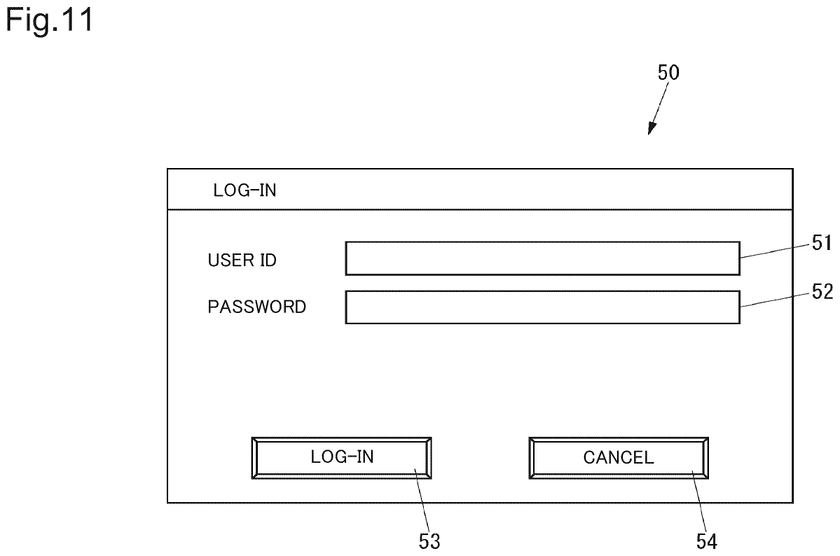

Referring to FIG. 10, at step S121 the device controller 37A causes the display device 32 to display a screen for logging in to the image forming apparatus 30 (hereinafter, “log-in screen 50”) (see FIG. 11).

FIG. 11 presents an example of the log-in screen 50. As shown in FIG. 11, the log-in screen 50 includes a text box 51, a text box 52, a log-in button 53, and a cancel button 54.

The text box 51 is a widget for inputting the user ID of the device user. The text box 52 is a widget for inputting the password of the device user. The log-in button 53 is a widget for causing the image forming apparatus 30 to permit the log-in to the image forming apparatus 30. The cancel button 54 is a widget for cancelling the log-in to the image forming apparatus 30.

Referring again to FIG. 10, after step S121 the device controller 37A decides whether the log-in button 53 has been pressed (step S122).

Upon deciding that the log-in button 53 has not been pressed (NO at step S122), the device controller 37A decides whether the cancel button 54 has been pressed (step S123).

Upon deciding that the cancel button 54 has not been pressed (NO at step S123), the device controller 37A returns to step S122.

Upon deciding that the cancel button 54 has been pressed (YES at step S123), the device controller 37A causes the display device 32 to erase the display of the log-in screen 50 (step S124), thus finishing the operation specified in FIG. 10.

Upon deciding that the log-in button 53 has been pressed (YES at step S122), the device controller 37A causes the display device 32 to erase the display of the log-in screen 50 (step S125).

After step S125, the device controller 37A decides whether the combination of the user ID, inputted in the text box 51 before the log-in button 53 was pressed, and the password inputted in the text box 52 before the log-in button 53 was pressed, is included in the user management information 36B (step S126).

Upon deciding that the combination of the inputted user ID and the inputted password is not included in the user management information 36B (NO at step S126), the device controller 37A causes the display device 32 to display a screen indicating the failure in logging in, for a predetermined time (e.g., 10 seconds) (step S127), and returns to step S121.

Upon deciding that the combination of the inputted user ID and the inputted password is included in the user management information 36B (YES at step S126), the device controller 37A permits the log-in with the user ID inputted (step S128), and finishes the operation specified in FIG. 10.

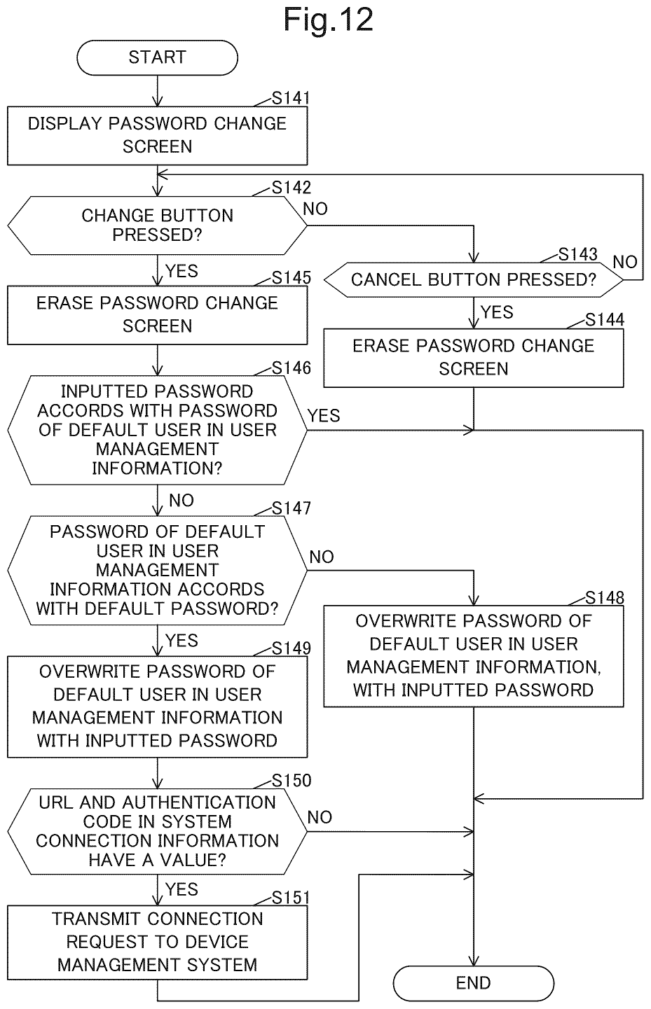

Hereunder, an operation of the image forming apparatus 30, performed when the password of the default user is changed, will be described. FIG. 12 is a flowchart showing the operation of the image forming apparatus 30, performed when the password of the default user is changed.

The default user can input, in a log-in state to the image forming apparatus 30, an instruction to start the action for changing the password of the default user (hereinafter, “instruction to start changing default user password”), through the operation device 31 to the image forming apparatus 30. When such instruction to start changing default user password is inputted, the device controller 37A of the image forming apparatus 30 executes the operation specified in FIG. 12.

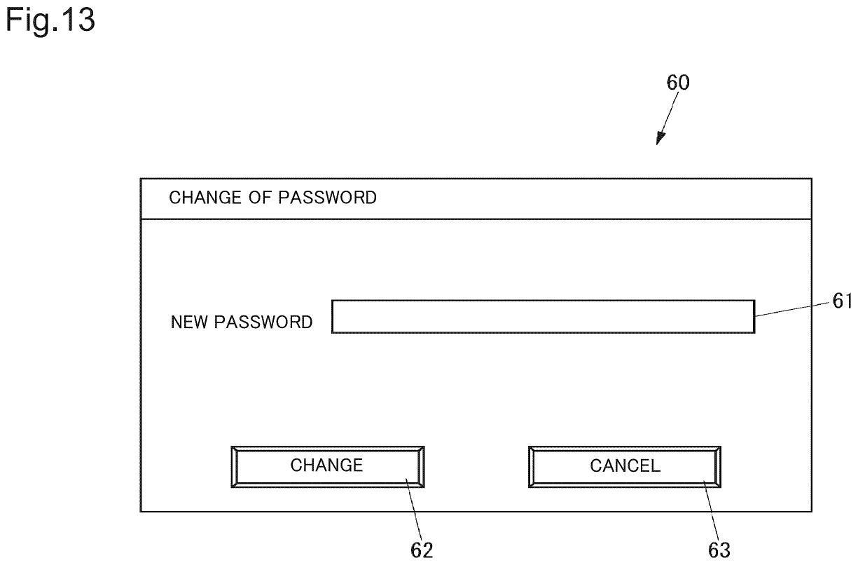

Referring to FIG. 12, at step S141 the device controller 37A causes the display device 32 to display a screen for changing the password of the default user (hereinafter, “password change screen 60”) (see FIG. 13).

FIG. 13 presents an example of the password change screen 60. As shown in FIG. 13, the password change screen 60 includes a text box 61, a change button 62, and a cancel button 63.

The text box 61 is a widget for inputting a new password. The change button 62 is a widget for causing the image forming apparatus 30 to register the new password of the default user. The cancel button 63 is a widget for cancelling the change of the password of the default user.

Referring again to FIG. 12, after step S141 the device controller 37A decides whether the change button 62 has been pressed (step S142).

Upon deciding that the change button 62 has not been pressed (NO at step S142), the device controller 37A decides whether the cancel button 63 has been pressed (step S143).

Upon deciding that the cancel button 63 has not been pressed (NO at step S143), the device controller 37A returns to step S142.

Upon deciding that the cancel button 63 has been pressed (YES at step S143), the device controller 37A causes the display device 32 to erase the display of the password change screen 60 (step S144), thus finishing the operation specified in FIG. 12.

Upon deciding that the change button 62 has been pressed (YES at step S142), the device controller 37A causes the display device 32 to erase the display of the password change screen 60 (step S145).

After step S145, the device controller 37A decides whether the password, inputted in the text box 61 before the change button 62 was pressed, accords with the password of the default user in the user management information 36B (step S146).

Upon deciding that the inputted password accords with the password of the default user in the user management information 36B (YES at step S146), the device controller 37A finishes the operation specified in FIG. 12.

Upon deciding that the inputted password does not accord with the password of the default user in the user management information 36B (NO at step S146), the device controller 37A decides whether the password of the default user in the user management information 36B accords with the default password indicated by the default password information 36C (step S147).

Upon deciding that the password of the default user in the user management information 36B does not accord with the default password indicated by the default password information 36C (NO at step S147), the device controller 37A overwrites the password of the default user in the user management information 36B, with the password inputted in the text box 61 before the change button 62 was pressed (step S148), and finishes the operation specified in FIG. 12.

Upon deciding that the password of the default user in the user management information 36B accords with the default password indicated by the default password information 36C (YES at step S147), the device controller 37A overwrites the password of the default user in the user management information 36B, with the password inputted in the text box 61 before the change button 62 was pressed (step S149).

After step S149, the device controller 37A decides whether there is a value of the URL and the authentication code, in the system connection information 36D (step S150).

Upon deciding that there is no value of the URL and the authentication code, in the system connection information 36D (NO at step S150), the device controller 37A finishes the operation specified in FIG. 12.

Upon deciding that there is a value of the URL and the authentication code, in the system connection information 36D (YES at step S150), the device controller 37A makes access to the URL in the system connection information 36D, and transmits a request for connection to the device management system 20 (hereinafter, “connection request”), to the device management system 20 (step S151). Then, the device controller 37A finishes the operation specified in FIG. 12.

The device controller 37A includes the device ID of the image forming apparatus 30 and the authentication code in the system connection information 36D, in the connection request of step S151.

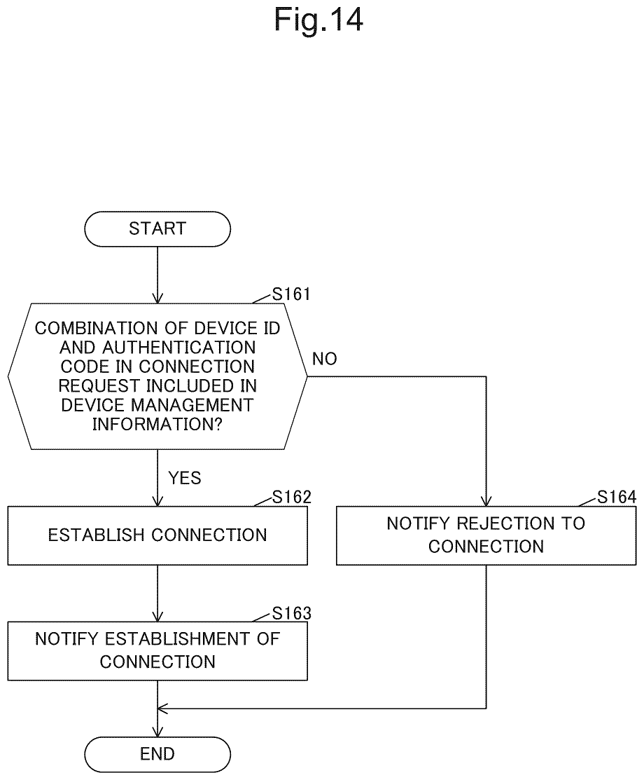

FIG. 14 is a flowchart showing an operation of the device management system 20, performed upon receipt of the connection request from the image forming apparatus 30. Upon receipt of the connection request from the image forming apparatus 30, the device manager 25A of the device management system 20 executes the operation specified in FIG. 14.

Referring to FIG. 14, the device manager 25A decides whether the combination of the device ID and the authentication code, included in the connection request, is included in the device management information 24B (step S161).

Upon deciding that the combination of the device ID and the authentication code in the connection request is included in the device management information 24B (YES at step S161), the device manager 25A establishes the connection to the image forming apparatus 30, which is the transmission source of the connection request (step S162).

After step S162, the device manager 25A notifies that the connection has been established between the device management system 20 and the transmission source of the connection request, in other words the image forming apparatus 30, to the transmission source of the connection request (step S163), and finishes the operation specified in FIG. 14.

Upon deciding that the combination of the device ID and the authentication code in the connection request is not included in the device management information 24B (NO at step S161), the device manager 25A notifies the rejection of the connection between the device management system 20 and the image forming apparatus 30 which is the transmission source of the connection request, to the transmission source of the connection request (step S164), and finishes the operation specified in FIG. 14.

The system user can confirm, in the log-in state to the device management system 20 realized from the web browser 45A of the user terminal 40, via a webpage provided by the device management system 20, various types of information of the image forming apparatus 30 being managed by the device management system 20, via the webpage provided by the device management system 20, from the web browser 45A.

The system user can also execute, in the log-in state to the device management system 20 realized from the web browser 45A of the user terminal 40, via the webpage provided by the device management system 20, various operations with respect to the image forming apparatus 30 being managed by the device management system 20, for example rebooting the same, through the device management system 20, via the webpage provided by the device management system 20, from the web browser 45A.

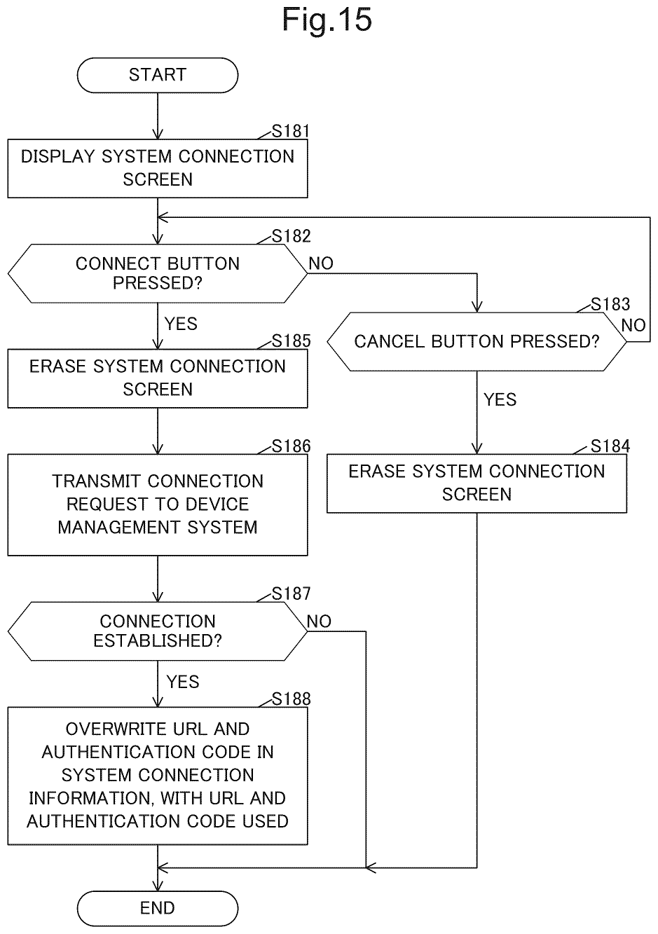

Hereunder, an operation of the system 10, performed when the image forming apparatus 30 is connected to the device management system 20, in accordance with the instruction to start system connecting action, will be described. FIG. 15 is a flowchart showing the operation of the image forming apparatus 30, performed when the instruction to start system connecting action is inputted.

When the image forming apparatus 30 is in the non-limited-operation status, the device user can input the instruction to start system connecting action to the image forming apparatus 30, through the operation device 31. When the instruction to start system connecting action is inputted, the device controller 37A of the image forming apparatus 30 executes the operation specified in FIG. 15.

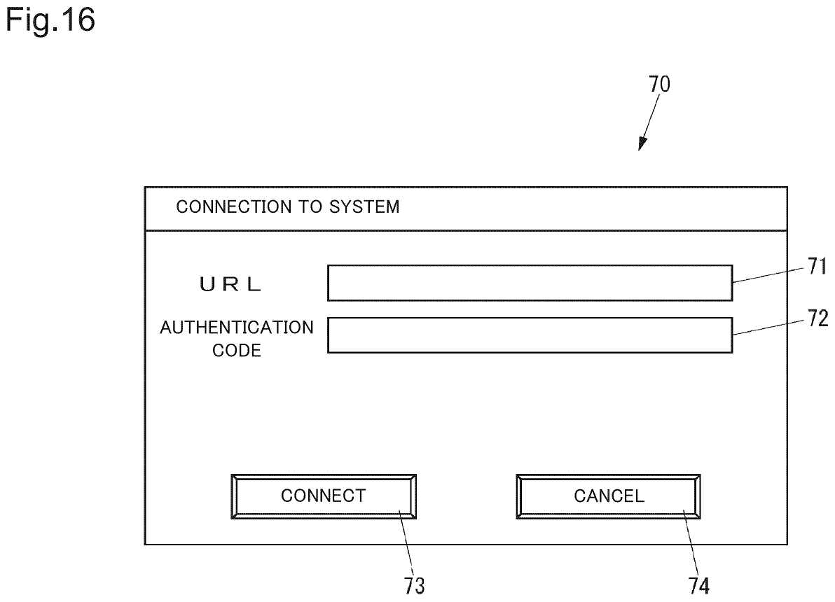

Referring to FIG. 15, at step S181 the device controller 37A causes the display device 32 to display a screen for connecting the image forming apparatus 30 to the device management system 20 (hereinafter, “system connection screen 70”) (see FIG. 16).

FIG. 16 presents an example of the system connection screen 70. As shown in FIG. 16, the system connection screen 70 includes a text box 71, a text box 72, a connect button 73, and a cancel button 74.

text box 71 is a widget for inputting the URL of the device management system 20. The text box 72 is a widget for inputting the authentication code for making connection to the device management system 20. The connect button 73 is a widget for causing the image forming apparatus 30 to establish connection to the device management system 20. The cancel button 74 is a widget for cancelling the connection to the device management system 20.

The URL of the device management system 20 and the authentication code are notified in advance from the system user to the device user.

Referring again to FIG. 15, after step S181 the device controller 37A decides whether the connect button 73 has been pressed (step S182).

Upon deciding that the connect button 73 has not been pressed (NO at step S182), the device controller 37A decides whether the cancel button 74 has been pressed (step S183).

Upon deciding that the cancel button 74 has not been pressed (NO at step S183), the device controller 37A returns to step S182.

Upon deciding that the cancel button 74 has been pressed (YES at step S183), the device controller 37A causes the display device 32 to erase the display of the system connection screen 70 (step S184), thus finishing the operation specified in FIG. 15.

Upon deciding that the connect button 73 has been pressed (YES at step S182), the device controller 37A causes the display device 32 to erase the display of the system connection screen 70 (step S185).

After step S185, the device controller 37A makes access to the URL inputted in the text box 71 before the connect button 73 was pressed, and transmits the connection request to the device management system 20 (step S186).

The device controller 37A includes the device ID of the image forming apparatus 30 and the authentication code inputted in the text box 72 before the connect button 73 was pressed, in the connection request of step S186.

Upon receipt of the connection request from the image forming apparatus 30, the device manager 25A of the device management system 20 executes the operation specified in FIG. 14.

Referring again to FIG. 15, after step S186, the device controller 37A of the image forming apparatus 30 decides whether the connection between the device management system 20 and the image forming apparatus 30 has been established (step S187).

After step S186, for example, the device controller 37A may decide that the connection between the device management system 20 and the image forming apparatus 30, in the case where the establishment of the connection between the device management system 20 and the image forming apparatus 30 is notified from the device management system 20, within a predetermined period of time.

For example, the device controller 37A may decide that the connection between the device management system 20 and the image forming apparatus 30 has failed to be established, in the case where the rejection of the connection between the device management system 20 and the image forming apparatus 30 is notified from the device management system 20, or where the establishment of the connection between the device management system 20 and the image forming apparatus 30 has not been notified from the device management system 20, within the predetermined period of time after step S186.

Upon deciding that the connection between the device management system 20 and the image forming apparatus 30 has been established (YES at step S187), the device controller 37A overwrites the URL and the authentication code in the system connection information 36D, with the URL and the authentication code used at step S186 (step S188).

Upon deciding that the connection between the device management system 20 and the image forming apparatus 30 has not been established (NO at step S187), or finishing the operation of step S188, the device controller 37A finishes the operation specified in FIG. 15.

Hereunder, an operation of the system 10, performed when the password of the default user of the image forming apparatus 30 is reset, in accordance with the request from the device management system 20, will be described.

There may be cases where the device user of the image forming apparatus 30 wishes to log in to the image forming apparatus 30, as the default user thereof, for example when the device user of the image forming apparatus 30 wishes to perform an operation with respect thereto, which is permitted only to authorized users.

However, normally the device user does not often log in to the image forming apparatus 30 as the default user thereof. Accordingly, the device user of the image forming apparatus 30 may have forgotten the password of the default user of the image forming apparatus 30, when the device user wishes to log in to the image forming apparatus 30, as the default user thereof.

The device user of the image forming apparatus 30 may wish, therefore, to reset the password of the default user of the image forming apparatus 30, for various reasons including having forgotten the password of the default user. When the device user of the image forming apparatus 30 wishes to reset the password of the default user of the image forming apparatus 30, the device user can request the system user to reset the password of the default user of the image forming apparatus 30.

The system user can instruct, for various reasons including having received the request to reset the password of the default user of the image forming apparatus 30, from the device user thereof, the device management system 20 to reset the password of the default user of the image forming apparatus 30, from the web browser 45A of the user terminal 40 via the webpage provided by the device management system 20.

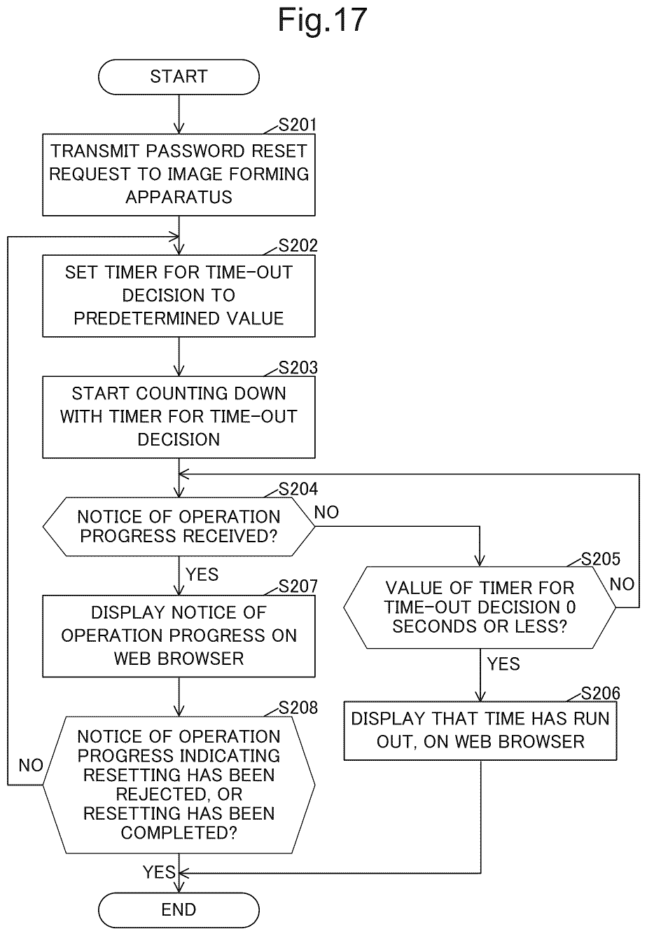

When the connection between the device management system 20 and the image forming apparatus 30 is established, the device manager 25A of the device management system 20 executes the operation specified in FIG. 17, upon receipt of the instruction to reset the password of the default user of the image forming apparatus 30, from the web browser 45A of the user terminal 40 via the webpage provided by the device management system 20.

FIG. 17 is a flowchart showing the operation of the device management system 20, performed upon receipt of the instruction to reset the password of the default user of the image forming apparatus 30.

Referring to FIG. 17, at step S201 the device manager 25A transmits the request to reset the password of the default user of the image forming apparatus 30 (hereinafter, “password reset request”), to the image forming apparatus 30.

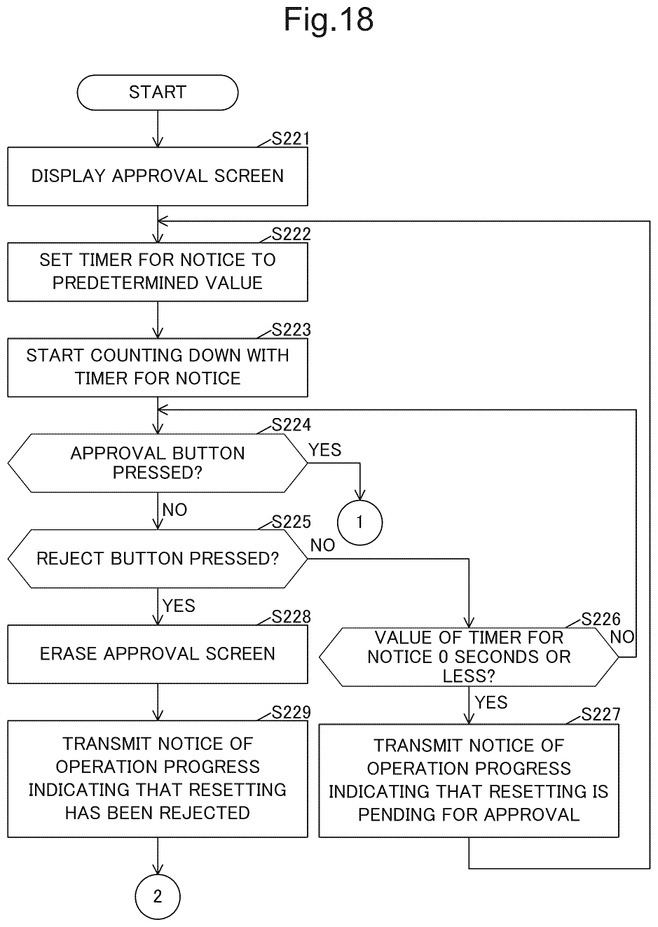

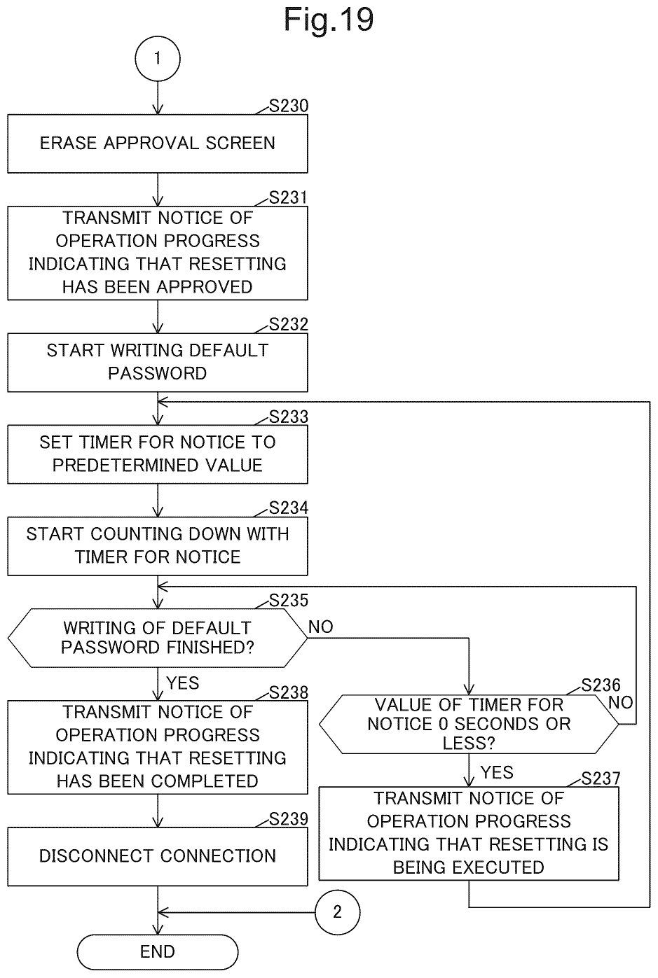

FIG. 18 is a flowchart showing an operation of the image forming apparatus 30, performed upon receipt of the password reset request from the device management system 20. FIG. 19 is a flowchart showing the process that follows the flowchart shown in FIG. 18.

Upon receipt of the password reset request from the device management system 20, the device controller 37A of the image forming apparatus 30 executes the operation specified in FIG. 18 and FIG. 19.

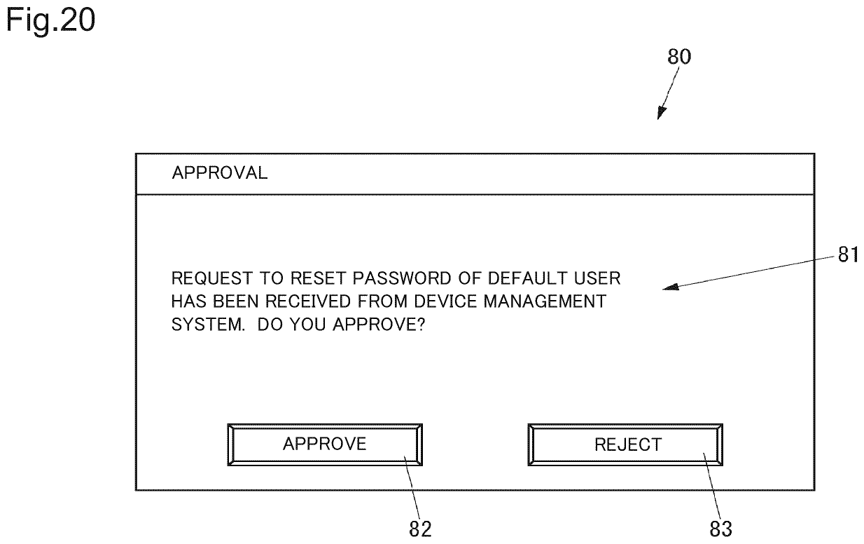

Referring to FIG. 18 and FIG. 19, at step S221 the device controller 37A of the image forming apparatus 30 causes the display device 32 to display a screen for acquiring the approval for resetting the password of the default user (hereinafter, “approval screen 80”) (see FIG. 20).

FIG. 20 presents an example of the approval screen 80. As shown in FIG. 20, the approval screen 80 includes a message 81, an approval button 82, and a reject button 83.

The message 81 is for requesting the device user to approve the resetting of the password of the default user. The approval button 82 is a widget for approving the resetting of the password of the default user. The reject button 83 is a widget for rejecting the resetting of the password of the default user.

Referring again to FIG. 18 and FIG. 19, after step S221 the device controller 37A sets a timer for notifying the progress of the operation being executed by the image forming apparatus 30 (hereinafter, “notice of operation progress”), to a predetermined value (step S222). The predetermined value may be, for example, 10 seconds.

After step S222, the device controller 37A starts to count down with the timer for notice (step S223).

After step S223, the device controller 37A decides whether the approval button 82 has been pressed (step S224).

Upon deciding that the approval button 82 has not been pressed (NO at step S224), the device controller 37A decides whether the reject button 83 has been pressed (step S225).

Upon deciding that the reject button 83 has not been pressed (NO at step S225), the device controller 37A decides whether the value of the timer for notice has reached 0 seconds or less (step S226).

Upon deciding that the value of the timer for notice has not reached 0 seconds or less (NO at step S226), the device controller 37A returns to step S224.

Upon deciding that the value of the timer for notice has reached 0 seconds or less (YES at step S226), the device controller 37A transmits the notice of operation progress, indicating that the resetting of the password of the default user is pending for approval, to the device management system 20 (step S227).

After step S227, the device controller 37A returns to step S222.

Upon deciding that the reject button 83 has been pressed (YES at step S225), the device controller 37A causes the display device 32 to erase the display of the approval screen 80 (step S228).

After step S228, the device controller 37A transmits the notice of operation progress, indicating that the resetting of the password of the default user has been rejected, to the device management system 20 (step S229), and finishes the operation specified in FIG. 18 and FIG. 19.

Upon deciding that the approval button 82 has been pressed (YES at step S224), the device controller 37A causes the display device 32 to erase the display of the approval screen 80 (step S230).

After step S230, the device controller 37A transmits the notice of operation progress, indicating that the resetting of the password of the default user has been approved, to the device management system 20 (step S231).

After step S231, the device controller 37A starts to overwrite the default password indicated by the default password information 36C, with the password of the default user in the user management information 36B (step S232).

After step S232, the device controller 37A sets the timer for notice to the predetermined value (step S233). The predetermined value may be, for example, 10 seconds.

After step S233, the device controller 37A starts to count down with the timer for notice (step S234).

After step S234, the device controller 37A decides whether the overwriting of the default password indicated by the default password information 36C, with the password of the default user in the user management information 36B, has finished (step S235).

Upon deciding that the overwriting of the default password has not finished (NO at step S235), the device controller 37A decides whether the value of the timer for notice has reached 0 seconds or less (step S236).

Upon deciding that the value of the timer for notice has not reached 0 seconds or less (NO at step S236), the device controller 37A returns to step S235.

Upon deciding that the value of the timer for notice has reached 0 seconds or less (YES at step S236), the device controller 37A transmits the notice of operation progress, indicating that the resetting of the password of the default user is being executed, to the device management system 20 (step S237).

After step S237, the device controller 37A returns to step S233.

Upon deciding that the overwriting of the default password has finished (YES at step S235), the device controller 37A transmits the notice of operation progress, indicating that the resetting of the password of the default user has been completed, to the device management system 20 (step S238).

After step S238, the device controller 37A disconnects the connection between the device management system 20 and the image forming apparatus 30 (step S239), thus finishing the operation specified in FIG. 18 and FIG. 19.

Referring again to FIG. 17, after step S201 the device manager 25A of the device management system 20 sets a timer for time-out decision to a predetermined value (step S202). The predetermined value may be, for example, 60 seconds.

After step S202, the device manager 25A starts to count down with the timer for time-out decision (step S203).

After step S203, the device manager 25A decides whether the notice of operation progress has been received from the image forming apparatus 30 (step S204).

Upon deciding that the notice of operation progress has not been received from the image forming apparatus 30 (NO at step S204), the device manager 25A decides whether the value of the timer for time-out decision has reached 0 seconds or less (step S205).

Upon deciding that the value of the timer for time-out decision has not reached 0 seconds or less (NO at step S205), the device manager 25A returns to step S204.

Upon deciding that the value of the timer for time-out decision has reached 0 seconds or less (YES at step S205), the device manager 25A displays a message indicating that the time has run out, on the web browser 45A of the user terminal 40, via the webpage provided by the device management system 20 (step S206), and finishes the operation specified in FIG. 17.

Upon deciding that the notice of operation progress has been received from the image forming apparatus 30 (YES at step S204), the device manager 25A displays the status indicated by the notice of operation progress received from the image forming apparatus 30, on the web browser 45A of the user terminal 40, via the webpage provided by the device management system 20 (step S207).

After step S207, the device manager 25A decides whether the notice of operation progress received from the image forming apparatus 30 is either indicating that the resetting of the password of the default user has been rejected, or indicating that the resetting of the password of the default user has been completed (step S208).

Upon deciding that the notice of operation progress received from the image forming apparatus 30 is neither indicating that the resetting of the password of the default user has been rejected, nor indicating that the resetting of the password of the default user has been completed (NO at step S208), the device manager 25A returns to step S202.

Upon deciding that the notice of operation progress received from the image forming apparatus 30 is either indicating that the resetting of the password of the default user has been rejected, or indicating that the resetting of the password of the default user has been completed (YES at step S208), the device manager 25A finishes the operation specified in FIG. 17.

Now, in the case of the existing multifunction peripherals, when the user of the multifunction peripheral, who wishes to log in to the multifunction peripheral as the default user thereof, has forgotten the password of the default user for logging in to the multifunction peripheral, the password of the default user has to be reset to a default value. In such a case, it often takes a long time to reset the password of the default user to the default value.

For example, in the case of having a service person, belonging to a service provider that provides the maintenance work for the multifunction peripheral, visit the site where the multifunction peripheral is installed, and execute the operation to reset the password of the default user to the default value, for the multifunction peripheral in question, or having the user of the multifunction peripheral enquire, for example a customer support center, about how to reset the password of the default user to the default value, and then execute the resetting accordingly with respect to the multifunction peripheral, the time required for resetting the password of the default user to the default value is prolonged.

According to the foregoing embodiment, in contrast, the image forming apparatus 30 resets, upon receipt of the request to reset the password of the default user, the password of the default user to the default value (i.e., default password) (step S232).

The mentioned arrangement eliminates the need to have the service person, belonging to the service provider that provides the maintenance work for the multifunction peripheral, visit the site where the multifunction peripheral is installed, and execute the operation to reset the password of the default user to the default value, for the multifunction peripheral in question, or have the user of the multifunction peripheral enquire, for example a customer support center, about how to reset the password of the default user to the default value, and then execute the resetting accordingly with respect to the multifunction peripheral. Therefore, the time required for resetting the password of the default user to the default value can be shortened.

In addition, upon receipt of the request to reset the password of the default user, the image forming apparatus 30 requests the user of the image forming apparatus 30 to approve the resetting of the password of the default user (step S221), and resets, upon acquiring the approval for resetting the password of the default user, from the user of the image forming apparatus 30 (YES at step S224), the password of the default user to the default value (step S232). Therefore, the password of the default user can be safely reset to the default value.

Further, when the password of the default user is the default value (YES at step S101), the image forming apparatus 30 restricts the operations other than the specific operation from being accepted (step S102). Therefore, the security level can be improved.

The image forming apparatus 30 disconnects the connection to the device management system 20 (step S239), upon receipt of the request to reset the password of the default user, from the device management system 20 managing the image forming apparatus 30, and resetting the password of the default user to the default value (YES at step S235).

Therefore, the image forming apparatus 30 can be prevented from being operated by the device management system 20, provided that acceptance of the operations other than the specific operation is restricted, because of the password of the default user according with the default value. As result, the security level can be improved.

When the password of the default user is changed from the default value, the image forming apparatus 30 is automatically reconnected to the device management system 20 (step S151). Therefore, the convenience in use can be improved. The electronic device according to the disclosure is exemplified by the image forming apparatus 30, in the foregoing embodiment. However, the electronic device according to the disclosure may be an electronic device other than the image forming apparatus 30.

Further, the computer-readable, non-transitory recording medium, having the device control program according to the embodiment recorded thereon, and the computer-readable, non-transitory recording medium, having the device management program according to the embodiment recorded thereon, can be exemplified by a hard disk, a CD-ROM, a DVD-ROM, or a semiconductor memory.

While the present disclosure has been described in detail with reference to the embodiments thereof, it would be apparent to those skilled in the art that various changes and modifications may be made therein within the scope defined by the appended claims.

What is claimed is;:

1. An electronic device comprising:
a communication device that communicates with an external device;
a storage device that stores therein a log-in password of a default user and a default value; and
a control device including a processor, and configured to act, when the processor executes a device control program, as a device controller that resets, upon receipt of a request to reset the log-in password via the communication device, the log-in password of the default user, by rewriting the log-in password to the default value.

2. The electronic device according to claim 1, further comprising:
a display device; and
an operation device that receives an input of an instruction of a device user,
wherein the device controller causes the display device, upon receipt of the request to reset the log-in password via the communication device, to display an approval screen for acquiring approval for resetting the log-in password, and
and resets the log-in password of the default user to the default value, upon receipt of the approval for resetting the log-in password, via the operation device.

3. The electronic device according to claim 2,
wherein the device controller restricts acceptance of operations other than a specific operation with respect to the operation device, when the log-in password of the default user accords with the default value.

4. The electronic device according to claim 3,
wherein the device controller disconnects connection to a device management system managing the electronic device, upon receipt of the request to reset the log-in password from the device management system via the communication device, and upon resetting the log-in password of the default user to the default value.

5. The electronic device according to claim 4,
wherein the device controller reconnects to the device management system, when the log-in password of the default user is changed from the default value.

6. The electronic device according to claim 3,
wherein the device controller keeps from restricting the acceptance of the operations other than the specific operation, when the log-in password of the default user discords with the default value.

7. A device management system that manages an electronic device, the device management system comprising:
a communication device that communicates with an external device; and
a control device including a processor, and configured to act, when the processor executes a device management program, as a device manager that transmits a request to reset a log-in password of a default user, to the electronic device via the communication device.

8. A computer-readable, non-transitory recording medium having a device control program recorded thereon, the device control program being configured to cause an electronic device including a communication device that communicates with an external device, a storage device that stores therein a log-in password of a default user and a default value, and a processor, to act, when the processor executes a device control program, as a device controller that resets, upon receipt of a request to reset the log-in password via the communication device, the log-in password of the default user, by rewriting the log-in password to the default value.

9. A computer-readable, non-transitory recording medium having a device management program for managing an electronic device, recorded thereon, the device management program being configured to cause a computer, including a communication device that communicates with an external device, and a processor, to act, when the processor executes the device management program, as a device manager that transmits a request to reset a log-in password of a default user, to the electronic device via the communication device.
